(19) United States
(12) Patent Application Publication
(10) Pub. No.: US 2009/0286648 A1
(43) Pub. Date: Nov. 19, 2009

(54) METHOD FOR CONTROLLING A BRIDGING CLUTCH IN A HYDRODYNAMIC TORQUE TRANSMISSION DEVICE

(75) Inventor: Andelko Vesenjak, Meckenbeuren (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/465,718

(22) Filed: May 14, 2009

(30) Foreign Application Priority Data
May 19, 2008 (DE) 10 2008 001 841.4

(51) Int. Cl. F16H 61/14; B60W 10/00

(52) U.S. Cl. 477/70

(57) ABSTRACT

A method is proposed for controlling a bridging clutch in a hydrodynamic torque transmission device of a vehicle, such that with reference to a predetermined load status of the vehicle the bridging clutch is closed in a predetermined gear (x) of the transmission, and the gear (x, x₁, x₂) in which the bridging clutch is closed, is selected as a function of the load status of the vehicle at the time.

This application claims priority from German patent application serial no. 10 2008 001 841.4 filed May 19, 2008.

### FIELD OF THE INVENTION

The present invention concerns a method for controlling a bridging clutch in a hydrodynamic torque transmission device in an automated transmission of a vehicle.

### BACKGROUND OF THE INVENTION

For example, from the document DE 100 25 882 A1 a torque transmission device, in particular for a motor vehicle, and a method for operating it are known. The torque transmission device comprises a control unit connected at times to a load status detection device. The load status detection device comprises a sensor device designed to detect the load status of the vehicle. The torque transmission device can adopt various shift conditions, which influence the relationship of the rotation characteristics. In this case a clutch device in the torque transmission device can be disengaged so that the input shaft is essentially mechanically decoupled from the output shaft. The clutch device can also be fully engaged, so that when a gear is engaged the input shaft is coupled in a rotationally fixed manner to the output shaft. The control unit can control the shift conditions of the torque transmission device in accordance with a predetermined characteristic. This known method, however, does not enable any control of a bridging clutch of a hydrodynamic torque converter.

Further, it is known from automotive technology that hydrodynamic torque converters are also used as torque transmission devices. Hydrodynamic torque converters usually comprise a bridging clutch which, in predetermined driving conditions of the vehicle, enable a rotationally fixed connection between the vehicle's motor and the transmission input shaft. In known methods the engagement of the bridging clutch is associated with a particular gear step. This assumes a particular vehicle weight. Thus, with the known methods, in relation to selecting the point in time when, or in which gear, the bridging clutch should be engaged, no account is taken of a varying vehicle mass. Overall, this results in an increase of the vehicle's fuel consumption.

### DETAILED DESCRIPTION OF THE PREFERRED EMBODIMENTS

The purpose of the present invention is to propose a method for controlling a bridging clutch in a hydrodynamic torque converter of the type indicated at the start, by means of which a bridging clutch control strategy that reduces the vehicle's fuel consumption can be implemented.

Accordingly, a method is proposed for controlling a bridging clutch in a hydrodynamic torque converter or a hydrodynamic torque transmission device in an automated transmission or suchlike of a vehicle, in which the bridging clutch is engaged in association with a predetermined load status of the vehicle and in a predetermined gear x of the transmission. According to the invention it is now provided that the gear in which the bridging clutch is engaged, is selected depending on the load status of the vehicle at the time, or adapted to the load status.

Thus, in an advantageous manner the gear in which the bridging clutch is engaged or disengaged is not fixed but variable, so that the control strategy of the bridging clutch can be adapted as a function of the respective vehicle weight detected or the loading of the vehicle.

In the context of a particular embodiment variant of the invention, it can be provided that to determine the load status of the vehicle it is determined whether a semitrailer, a trailer or suchlike is coupled to the vehicle. For example, this can be done very simply by appropriate sensors.

It is also a possibility, for determining the load status of the vehicle, to determine whether the vehicle has reached a specified limit value. For example, starting from the predetermined load condition, one or more specified limit values can be established. Then, for example, when the limit value is reached the gear in which the bridging clutch is engaged, is changed.

According to a possible version of the invention it can be provided that the bridging clutch is only engaged in a higher gear x₂or one with a larger transmission ratio than the predetermined gear x, if a semitrailer or a trailer is coupled to the vehicle and/or if the vehicle's mass is equal to or larger than the specified limit value. In this way, for example if a corresponding semitrailer or trailer coupling signal is detected, i.e. when a semitrailer or trailer is coupled to the vehicle, the engagement of the bridging clutch can be delayed in that the bridging clutch is only engaged in a higher gear than normal. Thus, the vehicle is driven by the hydrodynamic torque converter for longer than when its vehicle weight is lower.

In another embodiment variant of the present invention it can be provided that the bridging clutch is engaged for example in a lower gear x₁ than the predetermined gear x, if a semitrailer or trailer is coupled to the vehicle but the vehicle weight is smaller than the specified limit value. Thus the bridging clutch can be already engaged in a lower gear than normal, since despite the semitrailer or trailer the vehicle's mass is relatively low.

When no semitrailer or trailer is coupled to the vehicle, it can be provided that the bridging clutch is engaged in an even lower gear x₀ than the predetermined gears x or x₁ if no semitrailer or trailer is attached. Since in this condition of the vehicle its vehicle mass is lower than in the situations mentioned earlier, the bridging clutch can be engaged even sooner.

It is possible that the gear x₀ has a shorter transmission ratio than the gear x₁ and x₂ and that in turn the ratio of gear x₁ is shorter than that of gear x₂. Depending on the strategy and the transmission used, other possible transmission ratios can also be chosen. For example, it can be provided that the bridging clutch is normally engaged in the second gear x, so that the first gear is used as the starting gear. Beginning from this strategy, for example gear x₂ could be the third gear, gear x₁ the second gear and gear x₀ the first gear. These attributions, however, are only examples and can be changed at will in accordance with the desired strategy, for example even depending on the type of vehicle in each case. In this way the vehicle's fuel consumption can be optimized.

The method according to the invention can preferably be used with a vehicle designed as a tractor vehicle or utility vehicle. However, other fields of application are also conceivable.

1-8. (canceled)

9. A method of controlling a bridging clutch in a hydrodynamic torque transmission device in an automated transmission of a vehicle such that, with reference to a predetermined load status of the vehicle, the bridging clutch is engaged in a predetermined gear (x) of the transmission, the method comprising the step of:
selecting a gear (x, x₁, x₂) in which the bridging clutch is engaged as a function of the load status of the vehicle.

10. The method according to claim 9, further comprising the step of, when determining the load status of the vehicle, determining whether one of a semitrailer and a trailer is coupled to the vehicle.

11. The method according to claim 9, further comprising the step of, when determining the load status of the vehicle, determining whether a mass of the vehicle has reached a specified limit value.

12. The method according to claim 9, further comprising the step of disengaging the bridging clutch, only in a higher gear (x₂) than the predetermined gear (x), if either a semitrailer or a trailer is either attached to the vehicle and the mass of the vehicle is either equal to or larger than a specified limit value.

13. The method according to claim 9, further comprising the step of engaging the bridging clutch in a first gear (x₁) if either a semitrailer or a trailer is attached to the vehicle but the mass of the vehicle is lower than specified limit value.

14. The method according to claim 9, further comprising the step of, if neither a semitrailer nor a trailer is attached to the vehicle, engaging the bridging clutch in a lower gear (x₀) than the predetermined gear (x).

15. The method according to claim 12, further comprising the step of defining the lower gear (x₀) to have a transmission ration than both a first gear and the second gear (x₁, x₂), with the first gear (x₁) having lower transmission ratio than the second gear (x₂).

16. The method according to claim 9, further comprising the step of employing either a tractor vehicle or a utility vehicle as the vehicle.

17. A method of controlling a bridging clutch in a hydrodynamic torque transmission device in an automated transmission of either a tractor vehicle or a utility vehicle such that, with reference to a predetermined load status of the vehicle, the bridging clutch is engaged in a predetermined gear (x) of the transmission, the method comprising the step of:
selecting a gear (x, x₁, x₂) in which the bridging clutch is engaged as a function of the load status of the vehicle.
